(19) United States
(12) Patent Application Publication
(10) Pub. No.: US 2004/0076465 A1
(43) Pub. Date: Apr. 22, 2004

(54) Stud weldable mount and method

(75) Inventor: Gerard G. Geiger, Jackson, WI (US)

Correspondence Address: RYAN KROMHOLZ & MANION, S.C., POST OFFICE BOX 26618, MILWAUKEE, WI, 53226, US

(73) Assignee: Hellermann Tyton Corporation

(21) Appl. No.: 10/617,338

(22) Filed: Jul. 10, 2003

Related U.S. Application Data
(60) Provisional application No. 60/395,243, filed on Jul. 11, 2002.

(51) Int. Cl. F16B 1/00

(52) U.S. Cl. 403/278

(57) ABSTRACT

A mounting assembly and method for securing elongated items to a metallic structural member. In one embodiment, the assembly may include an apertured mount member, an elongated tie having a circumscribing strap, and a weld stud fastener. The mount member includes a plurality of apertures including at least one for receiving the circumscribing strap and at least one for receiving the weld stud fastener. The tie and strap secures or cradles the elongate items to the mount member, and the weld stud fastener is used to stud weld the mount member and attached elongate items to the metallic structural member. The resulting assembly holds the items adjacent a metallic structural member by way of a stud weld.

### RELATED APPLICATIONS

This application claims the benefit of Provisional Patent Application Serial No. 60/395,243, filed 11 Jul. 2002, which claims the benefit of Provisional Patent Application Serial No. 60/382,436, filed 22 May 2002.

### BACKGROUND OF THE INVENTION

This invention generally relates to specialized mounts for use with cable ties in securing elongate items, such as wires, cables, hoses, tubing, or conduits to an adjacent metallic structural member. More particularly, the invention relates to a mount that can be secured to a base metal by stud welding the mount to the metallic structural member.

Molded plastic cable ties are known in the art and are used to secure wires, cables, hoses, tubing, or other elongate articles in tight bundles.

Presently, mounting supports used in conjunction with cable ties or other strap-like bundling means are limited to configurations in which the mount and attached items are secured to a structural support member by way of communicating apertures through the structural member and mount. This arrangement typically requires drilling and tapping through the structural member to create the attachment aperture. This attachment means is sufficient in applications using readily borable support material, but is not practical when an aperture is not easily made in a predetermined support structure, such as when the reverse side of the support structure is not accessible. Further, the support material may be of an unworkable thickness. Also to be considered is the process of drilling and possibly tapping an aperture in the support member, which may be undesirably slow and labor intensive, adding to the overall cost of the end product. It may also be undesirable to create an aperture in a support member, such as in instances in which leakage or corrosion through the aperture is possible.

The present invention provides a mounting assembly that is stud welded directly onto the support surface of a metallic support member without the need for an aperture through the support member itself.

Stud welding is a high-speed joining process in which a stud or other metal part is affixed to a metal support structure. Metals that may be stud welded include steel, stainless steel and aluminum, among others. A weld gun loaded with a stud places the stud in contact with the metallic support structure. When the weld gun is activated, the gun tip initiates an electrical arc to melt the stud base and the contacted area of the metal support structure. The stud is then forced into the melted area in the support structure and is held in place until the metal solidifies and the bond is formed. In most instances, a stud weld is stronger than the stud itself and is compatible with most weldable materials, including dissimilar materials. The stud welding process allows welding to thin and sheet metal grade support material with no reverse side marking, as well as providing structural-type strength in welding to heavier support materials. Since the entire process is accomplished in milliseconds, bonds formed in this way lend themselves to high volume production and automated processes. Further, stud welding eliminates drilling and tapping of apertures through the support structure, provides optimal bond strength, avoids reverse side marking, and saves time and cost.

### SUMMARY OF THE INVENTION

The present invention provides a mounting assembly for use in securing bundled articles to a metal support structure using a stud welding technique. The assembly includes a mount element and, optionally, an elongated cable tie having a strap portion for circumscribing bundled articles. The mount element includes at least one opening therethrough, a base surface, and one or more support surfaces. The mount element is preferably interposed between one or more elongate items to be secured and a metallic structural member.

In a preferred embodiment, the mount member includes a stud opening which is arranged to receive a stud for stud welding, and a tie opening arranged to receive a conventional cable tie. The mount member is further provided with a mount support surface to cradle, support, separate, and stand-off bundled items, with a base or mounting surface adapted for supporting engagement with a metallic structural member.

In an alternative embodiment, a cable tie strap may be integrally formed with the mount element.

In yet another embodiment, the mount element may include at least one integrally formed fastening bracket.

It is an object of the present invention td provide a stud weldable mounting assembly that is convenient to use and economical in manufacture.

It is a further object of the present invention to provide a stud weldable mounting assembly for use in combination with conventional cable ties to provide cradling support of bundled items on a stud weldable surface.

It is a further object of the invention to provide a mounting assembly that can be stud welded to a metallic supporting structure.

### DESCRIPTION OF THE DRAWINGS

FIG. 1 is a perspective view of the stud weldable mounting assembly as installed on a supporting structural member, with a supported bundle being shown in phantom.

FIG. 1a is a perspective view of the mount member shown in FIG. 1.

FIG. 2 is a front elevational view of the mount member and weld stud fastener shown in FIG. 1, but prior to welding to a structural member and insertion of cable tie.

FIG. 3 is a side elevational view of the mount member shown in FIG. 2.

FIG. 4 is a top plan view of the stud weld mount member shown in FIG. 2.

FIG. 5 is a longitudinal section of the mount member shown in FIGS. 2-4 and taken along lines 5-5 of FIG. 4 and showing a radially extending ferrule.

FIG. 6a is a perspective view of the stud weldable mount member illustrated in FIG. 1, but showing the weld stud in position prior to welding to a supporting structural member.

FIG. 6b is a perspective view of the stud weldable mount member illustrated in FIG. 6a, but showing the weld stud after welding and severing and removal of the upper portion of the stud.

FIG. 6c is a perspective view of the stud weldable mount member illustrated in FIGS. 1, 6a, and 6b, but showing a cable tie being inserted in the tie aperture.

FIG. 7 is a perspective view of a stud weldable mount member similar to that shown in FIGS. 1-6, but showing a countersunk ferrule.

FIG. 8 is a longitudinal section of the stud weldable mount member shown in FIG. 7 and taken along lines 8-8 of FIG. 7, and showing the countersunk, radially extending ferrule.

FIG. 9 is a bottom perspective view of the stud weldable mount member shown in FIG. 7.

FIG. 9a is a bottom perspective view of the stud weldable mount member seen in FIG. 9, but showing an alternative, sharply pointed fastener base.

FIG. 10 is a perspective view of a stud weldable mount member similar to that shown in FIGS. 1-9a, but showing double, countersunk ferrules.

FIG. 11 is a longitudinal section of the stud weldable mount member shown in FIG. 10 and taken along lines 11-11 of FIG. 10, and showing the double, countersunk, radially extending ferrules.

FIG. 12 is a bottom perspective view of the stud weldable mount member shown in FIG. 10.

FIG. 12a is a bottom perspective view of the stud weldable mount member seen in FIG. 12, but showing an alternative, sharply pointed fastener base.

FIG. 13 is a perspective view of a stud weldable mount member similar to that shown in FIGS. 1-12a, but showing an embedded ferrule.

FIG. 14 is a longitudinal section of the stud weldable mount member shown in FIG. 13 and taken along lines 14-14 of FIG. 13, and showing the embedded ferrule.

FIG. 15 is a bottom perspective view of the stud weldable mount member shown in FIG. 13.

FIG. 15a is a bottom perspective view of the stud weldable mount member seen in FIG. 15, but showing an alternative, sharply pointed fastener base.

FIG. 16 is a perspective view of a stud weldable mount member similar to that shown in FIGS. 1-15a, but showing an embedded, radially extending ferrule.

FIG. 17 is a longitudinal section of the stud weldable mount member shown in FIG. 16 and taken along lines 17-17 of FIG. 16, and showing the embedded, radially extending ferrule.

FIG. 18 is a bottom perspective view of the stud weldable mount member shown in FIG. 16.

FIG. 18a is a bottom perspective view of the stud weldable mount member seen in FIG. 18, but showing an alternative, sharply pointed fastener base.

FIG. 19 is a perspective view of an alternative embodiment stud weldable mounting assembly showing an integrally formed stud weld mount member and cable tie with weld stud fastener in position prior to welding to a supporting structural member.

FIG. 20 is a perspective view of the alternative embodiment stud weldable mounting assembly seen in FIG. 19 and showing the cable tie strap inserted in the tie aperture, and the weld stud after welding.

FIG. 21 is a perspective view of the embodiment seen in FIGS. 19 and 20, but showing a support structure and bundle in phantom and with stud extension portion removed.

FIG. 22 is a perspective view of an alternative embodiment stud weldable mounting assembly showing a clip mount with weld stud fastener in position after being welded to a supporting structural member, with a supporting structural member and bundles shown in phantom.

FIG. 23 is a perspective view of the alternative embodiment stud weldable mounting assembly shown in FIG. 22, but prior to welding on a structural member and positioning of bundles.

FIG. 24 is a front elevational view of the stud weldable mounting assembly shown in FIG. 23.

FIG. 24a is a front elevational view of the stud weldable mounting assembly shown in FIG. 24, but showing an alternative, sharply pointed fastener base.

FIG. 25 is a longitudinal section of the stud weldable mount member shown in FIG. 23 and taken along lines 25-25 of FIG. 23, and showing an embedded ferrule.

FIG. 26 is a perspective view of an alternative embodiment stud weldable mounting assembly showing a cradle clamp mount with weld stud fastener in position prior to welding to a supporting structural member.

FIG. 27 is a front plan view of the assembly illustrated in FIG. 26 but showing the loop in the closed position with the strap engaged by the pawl structure.

FIG. 28 is a cross sectional view of the assembly of FIG. 27 and taken along lines 28-28 thereof.

FIG. 29 is a front plan view of the assembly illustrated in FIGS. 26-28, but showing the weld stud after welding to a support structure.

FIG. 30 is a perspective view of an embodiment of a stud weldable mount member similar to that shown in FIGS. 1-18a, but having a ferrule with a chamfered portion.

FIG. 31 is a longitudinal section of the stud weldable mount member shown in FIG. 30 and taken along lines 31-31 of FIG. 30, and showing a chamfered ferrule and corresponding beveled stud aperture.

FIG. 32 is a bottom perspective view of the stud weldable mount member shown in FIG. 30.

### DETAILED DESCRIPTION

Although the disclosure hereof is detailed and exact to enable those skilled in the art to practice the invention, the physical embodiments herein disclosed merely exemplify the invention which may be embodied in other specific structure. While the preferred embodiment has been described, the details may be changed without departing from the invention, which is defined by the claims.

Like features and structural elements are referred to by like reference characters.

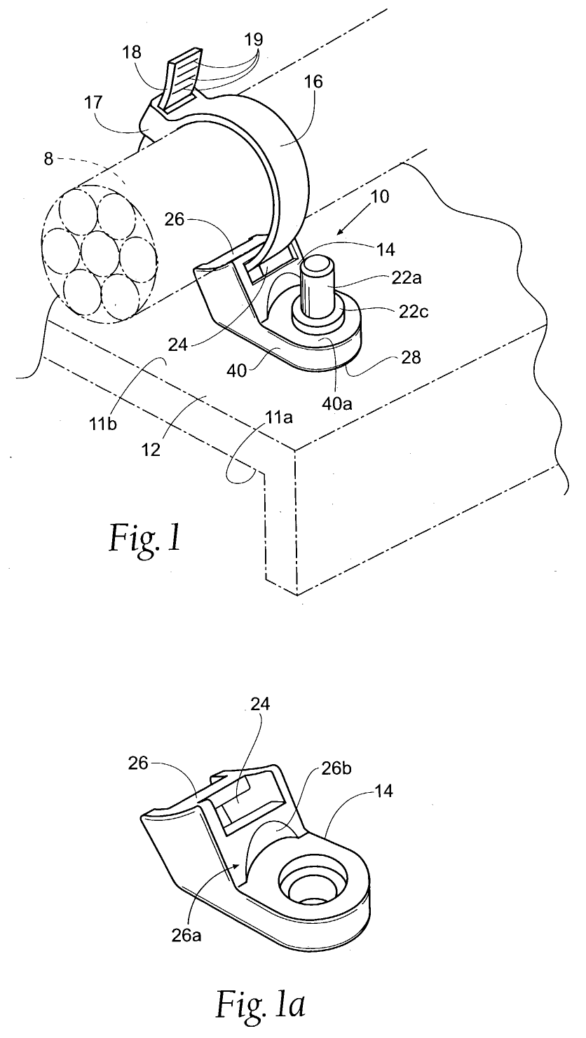

Referring to the drawings, and in particular to FIGS. 1-5, inclusive, a mounting assembly 10 embodying the various features of the invention is shown. The assembly 10 functions to secure elongate items, such as wires, cables and the like into bundles 8 (shown in phantom) and to secure the bundles 8 to an adjacent metallic structural member 12. It will be apparent that the “bundle” 8 may comprise multiple wires, conduits, or cables that are flexible or rigid, hot or cold, or fluid transporting hoses or tubes. Some elongate items may also be contained within the bore of a conventional tubular conduit. The assembly 10 is particularly well suited for use in applications requiring fastening to a metallic structural member 12. The present invention is especially useful in situations characterized by limited access to the reverse side 11a of the structural member 12 or in instances when it is not feasible to mount to the support surface 11b of the structural member 12 by way of a conventional nut and bolt arrangement.

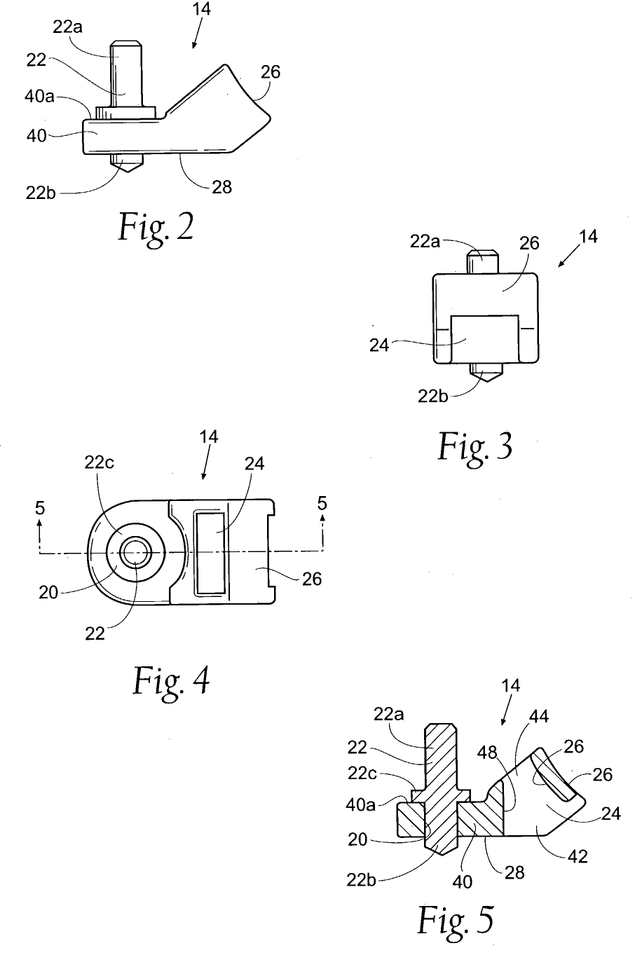

As illustrated in the view of FIG. 1, the assembly 10 includes two principal components, namely an integrally formed mount member 14 and a cable tie 16 having an elongate strap portion 18 molded with a plurality of serrations 19 conventionally engagable with a locking pawl (not shown) located integrally of the cable tie head 17. With reference to FIGS. 2-5, inclusive, the mount member 14 with stud weld fastener 22 is seen in detail.

The mount member 14 is shown without the stud weld fastener 22 in FIG. 1a. The mount member has an angularly extending arm 40 (see FIG. 1) with stud aperture 20 that receives the stud weld fastener 22 (see FIG. 1). An arched surface support 26 has a tie aperture 24 for receiving the cable tie 16. The arched surface support 26 is shown with an H-shaped arrangement. While not necessary for the invention, such an arrangement provides added support for the bundle 8 while minimizing the area that the cable tie 16 must maneuver to engage the mount member 14. Further, the arched surface of the support 26 fits the shape of the bundle 8 and contributes to securely hold the bundle 8 in place. The base 26a of the support surface 26 is shown as a solid section for added support, but may also be minimized or removed to allow more access for the bundle strap tie 16. Also, a notch 26b may be integral with the base 26a to allow sufficient room for the stud weld fastener 22 to be placed in the stud aperture without interfering with the support surface 26. Once again, this is not necessary for the invention and will not be necessary if the base 26a is not utilized in a specific embodiment of the invention.

The mount member 14 comprises the arched support surface 26, and the angularly extending arm 40. The arm 40 further includes an underside base surface 28 with stud aperture 20 (see FIG. 5) extending therethrough. The aperture 20 is arranged to receive a stud weld fastener 22. The arched support surface 26 is arranged for supporting engagement of a bundle 8, as shown in phantom in FIG. 1, while the underside base surface 28 mates with the support surface 11b of the metallic structural member 12 (see FIG. 1). The arched support surface 26 is relatively wide and creates broad surface contact with the bundle 8 to minimize pinching and crushing of the bundle 8 or its components. The mount member 14 is further provided with the tie aperture 24 (see FIGS. 4 and 5) for receiving and guiding the conventional cable tie 16. As best seen in FIG. 5, the tie aperture 24 is provided with a relatively distended end 42 and a constricted end 44. The constricted end 42 provides a convenient entrance for feeding the end of the strap portion 18 of the cable tie 16 into the aperture 24. The distended end 42 opens toward the base surface 28, while the constricted end 44 terminates at the opposite surface. As further seen in FIG. 5, the tie aperture 24 includes an inwardly tapered wall surface 46 and an inner wall surface 48. The inner wall surface 48 extends substantially parallel to the axis of the stud weld fastener 22 and stud aperture 20. The exterior surface of the tapered wall surface 46 corresponds to the arched support surface 26. The tie aperture 24 provides a throughway for receiving the cable tie 16 used to securely engage the bundle 8 to arched support surface 26 (see FIG. 1).

As is best seen in FIGS. 4 and 5, the mount member 14 includes a stud aperture 20 for receiving a stud weld fastener 22, and a tie aperture 24 for receiving the strap 18 of cable tie 16. As seen particularly in FIG. 5, the stud weld fastener 22, arranged to extend through the aperture 20, preferably includes a supporting extension 22a, base 22b and a radially extending ferrule 22c engagable with the upper surface 40a of arm portion 40 of the mount member 14.

The mount member 14 can be fabricated from any non-metallic material. The preferred material is nylon 6/6. Alternatively, any suitable plastic material could also be used.

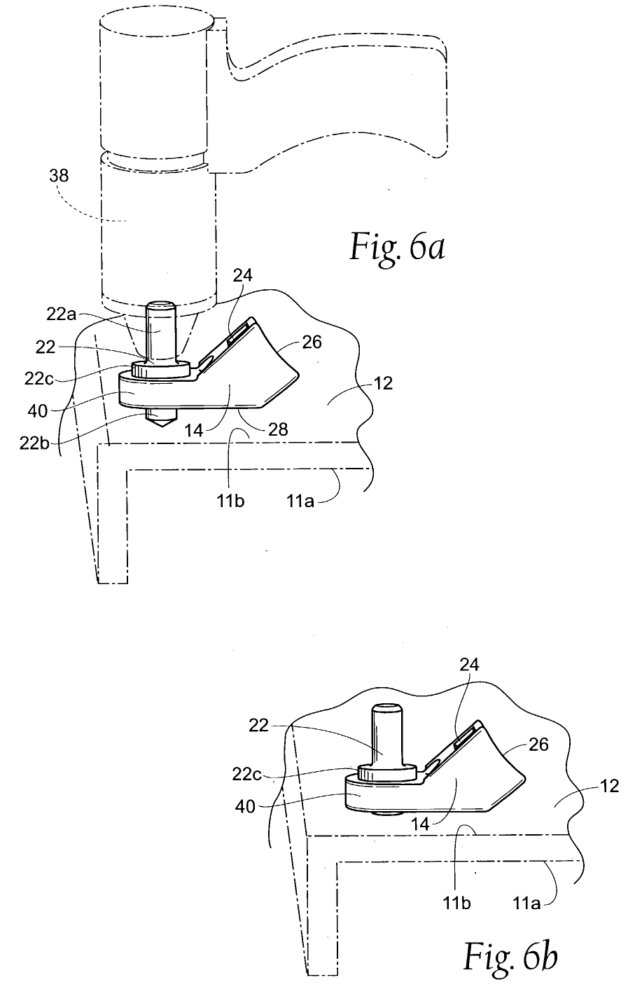

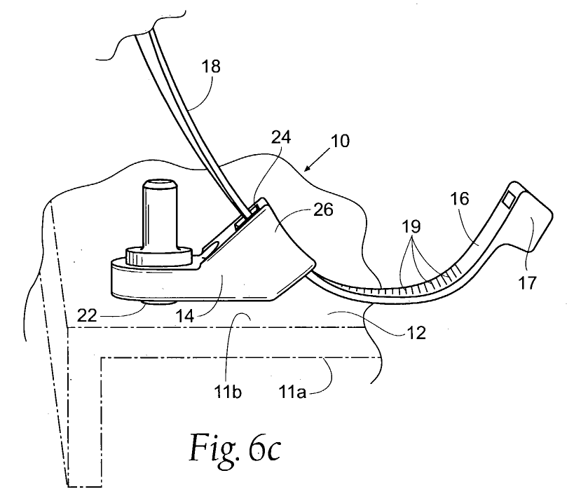

Installation of the assembly 10, illustrated in FIGS. 1-5, may be seen in the views of FIGS. 6a-6c. The mount member 14 is molded with the stud weld fastener 22 extending through the stud aperture 20. The fastener 22 includes a supporting extension 22a and a base 22b. The extension 22a is arranged for insertion into the bore of a stud welding gun 38 (shown in phantom) during the stud welding procedure. The stud welding gun 38 with attached extension 22a and mount member 14 presses the stud fastener base 22b against the support surface lib of the structural member 12 to be mounted. Upon activation of the stud welding gun 38, an electrical arc between the fastener 22 and the structural member 12 fuses the base 22b of the stud fastener 22 and the contacted area in the structural member 12. As shown in FIG. 6b, the stud fastener 22 and attached mount member 14 is pushed into the fused area until the metal solidifies and a bond is formed. The extension 22a may be removed by conventional means such as sawing and/or grinding, or the like. As shown in FIG. 6c, a cable tie 16 strap 18 is then passed through the tie aperture 24 for circumscribing a bundle 8 to be placed in position for support.

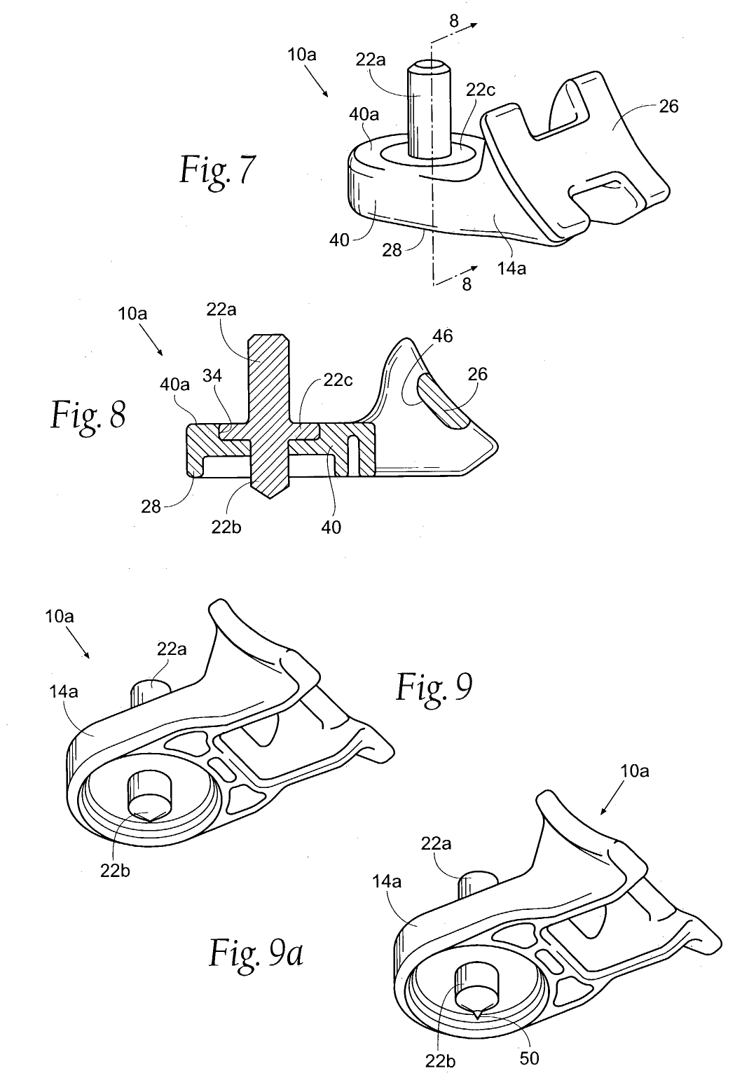

Referring now to FIGS. 7-9a, an alternative embodiment mounting assembly 10a may be seen. As seen particularly in FIG. 8, the mount member 14a may include an arm 40 having an upper surface 40a including a countersunk portion 34. Countersunk portion 34 may be adapted to receive the radially extending ferrule 22c of stud fastener 22. As shown in these views, the countersunk ferrule 22c allows the upper surface 40a of arm 40 to remain relatively smooth. FIG. 9a illustrates an alternative stud weld fastener 22 having a base portion 22b with a modified, sharply pointed end 50. The pointed end 50 may be desired, when, for example, the metallic structural member 12 is painted, and it is necessary to pierce the treated surface immediately prior to welding.

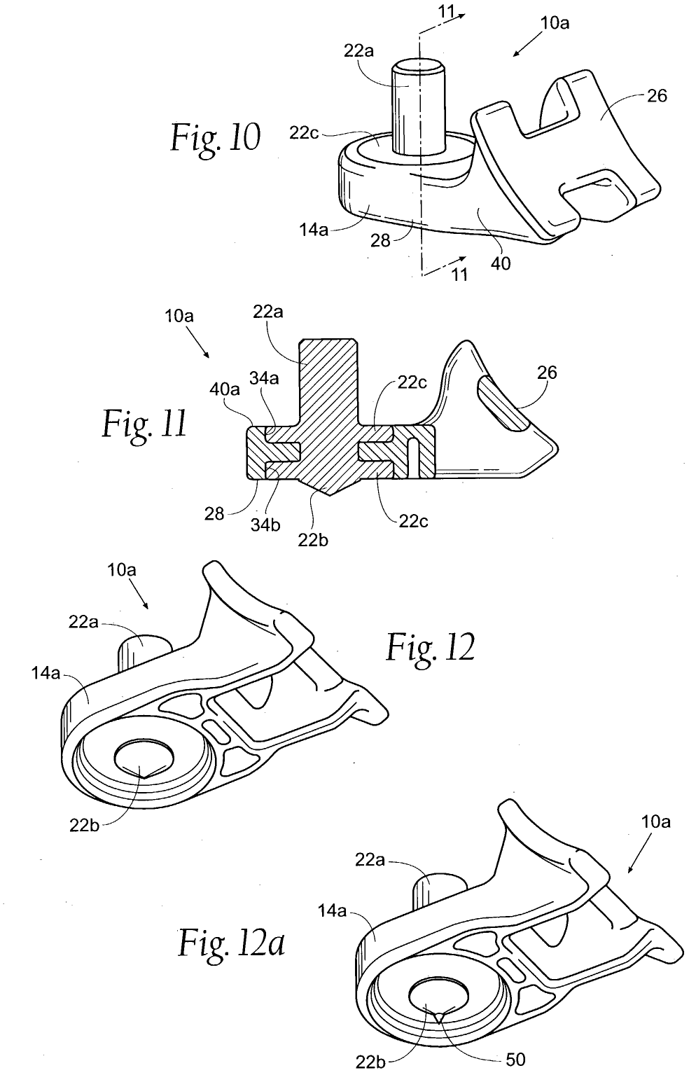

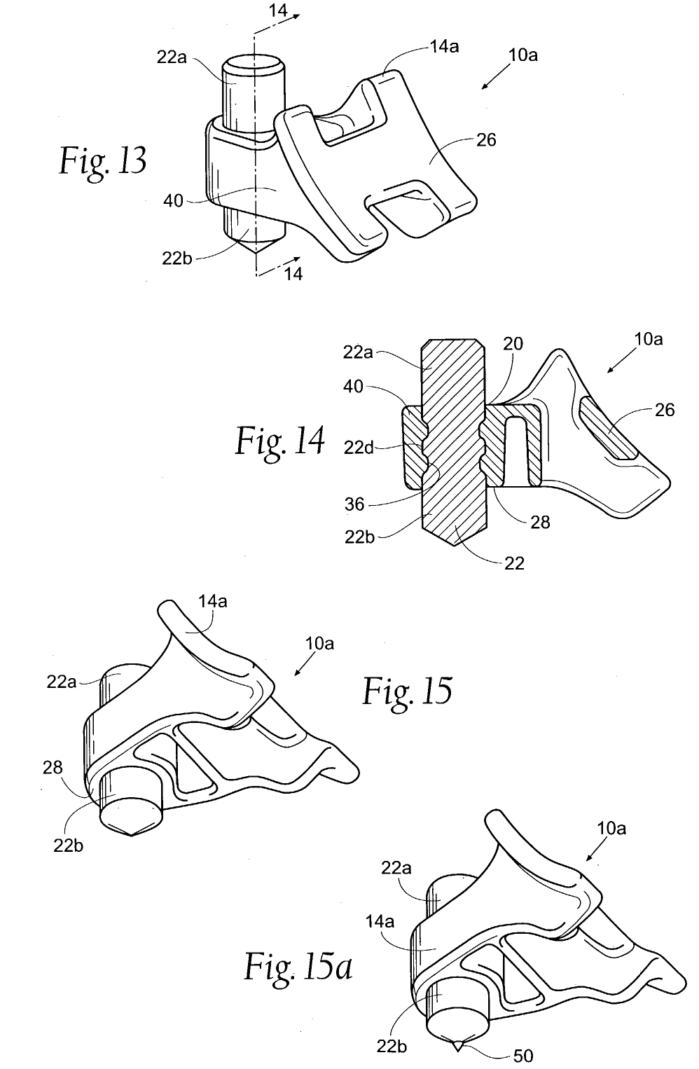

As illustrated in FIGS. 10-12a, inclusive, another alternative embodiment mounting assembly 10a is seen. As seen, the mount member 14a may include an arm 40 having countersunk portions 34a, 34b in both the upper surface 40a and the base surface 28, respectively. Further, the assembly 10a includes a stud weld fastener 22 having two, radially extending, axially spaced, ferrules 22c. The spaced-apart ferrules 22c are each respectively received in the countersunk portions 34a, 34b. This configuration may be desired for added strength. FIG. 12a shows the embodiment of FIGS. 10-12 with modified base 22b having a pointed end 50.

FIGS. 13-15a, inclusive, illustrate yet another alternative embodiment mounting assembly 10a. As will be observed particularly in FIG. 14, the mount member 14a may include a stud aperture 20 having an irregular, generally undulating, inner surface 36. Further, the assembly includes a stud weld fastener 22 having an irregular portion 22d located intermediate the extension 22a and the base 22b. The irregular portion 22d is configured for mating engagement of the generally undulating, irregular inner surface 36 of stud aperture 20. FIG. 15a shows the embodiment of FIGS. 13-15 with modified base 22b having the pointed end 50.

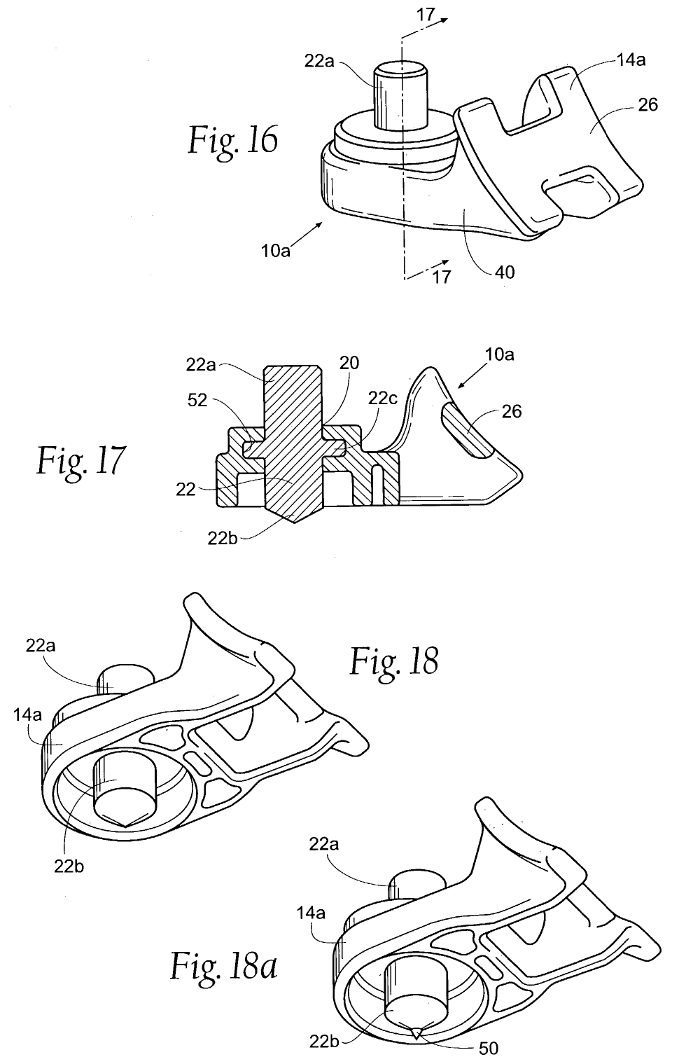

As revealed in FIGS. 16-18a, inclusive, still another alternative embodiment mounting assembly 10a is illustrated. As illustrated, particularly in FIG. 17, the mount member 14a may include a stud aperture 20 having an annular cavity 52. Further, the assembly includes a stud weld fastener 22 having a radially extending ferrule 22c located intermediate the extension 22a and the base 22b. The radially extending ferrule 22c is adapted to be received in the annular cavity 52 in stud aperture 20. FIG. 18a shows the embodiment of FIGS. 16-18 with modified base 22b having pointed end 50.

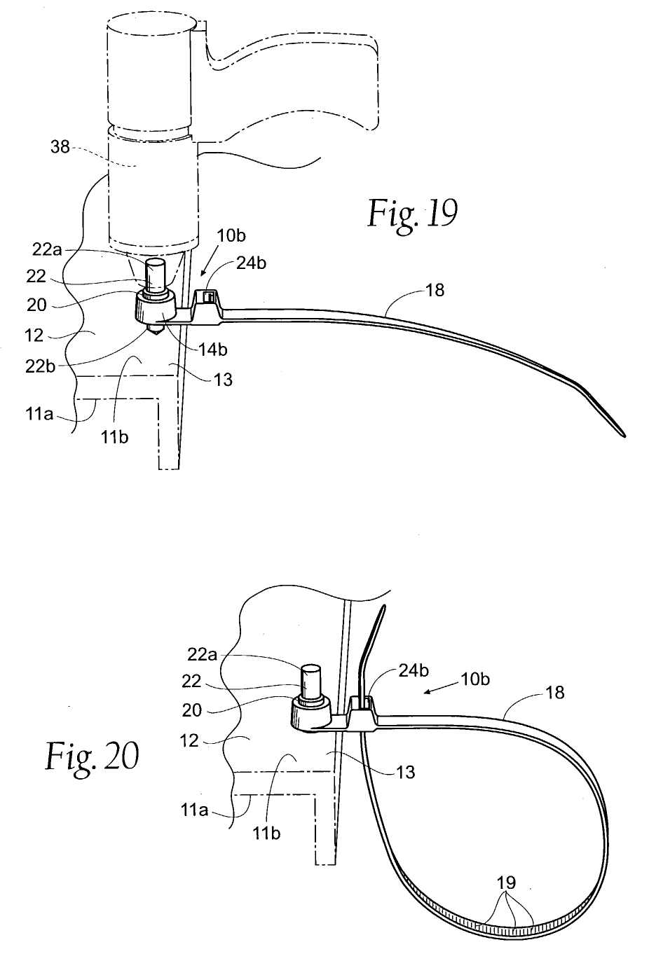

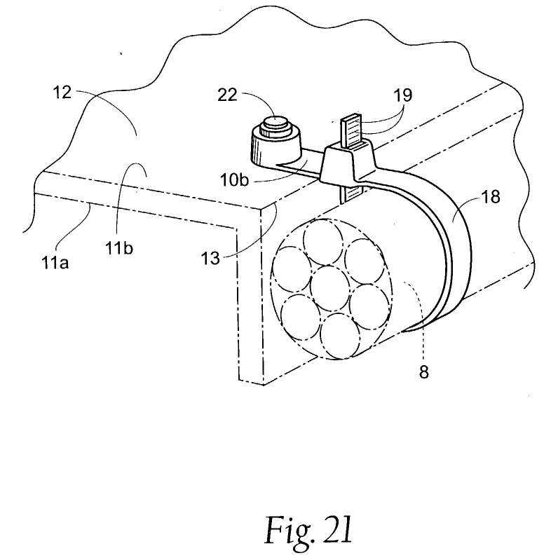

An alternative embodiment mounting assembly lob may be seen in FIGS. 19-21, inclusive. In this embodiment, the mount member 14b and strap 18 are integrally formed. As in the embodiments shown in FIGS. 1-18b, the mount member 14b of this alternative embodiment includes a tie aperture 24a and a stud aperture 20 for receiving a stud weld fastener 22 having a projecting extension 22a. In this embodiment, as well as in the embodiment of FIGS. 1-18c, the extension 22a may be removed by conventional sawing and/or grinding techniques after being welded to the structural member 12. The stud aperture 20 of alternative assembly 10b is preferably of a diameter to allow interference fit for an inserted stud weld fastener 22. The integrally formed strap portion 18 preferably includes serrations 19 which extend transversely across the strap 18. The serrations 19 are dimensioned to interlock with a corresponding pawl (not shown) in the tie aperture 24a. It is to be noted that alternative embodiment assembly 10b may be used to support bundle 8 against a structural member 12 having an edge 13.

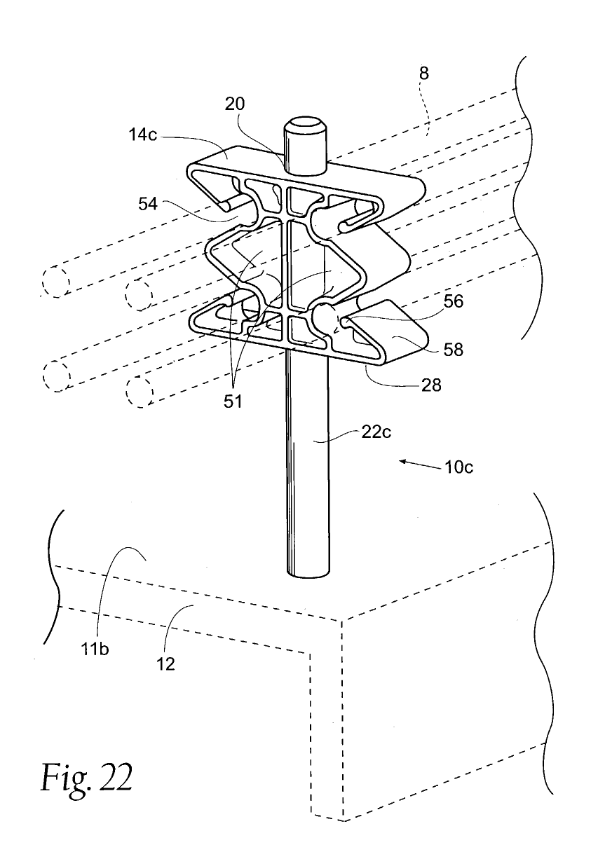

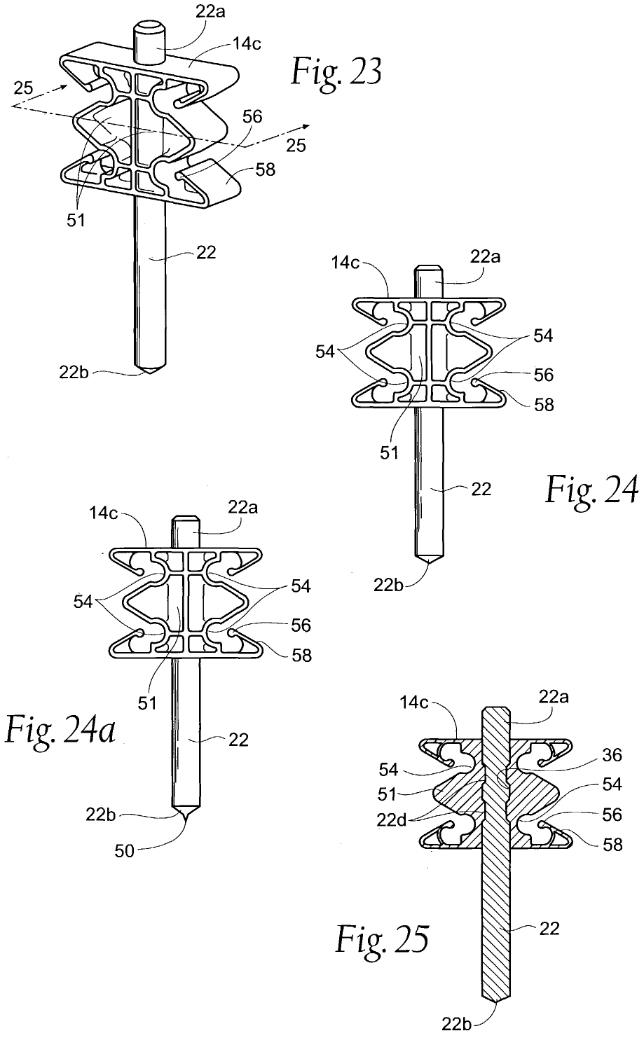

Another alternative embodiment mounting assembly 10c may be seen in FIGS. 22-25, inclusive. As illustrated in these views, the assembly 10c includes an integrally formed mount member 14c having a stud aperture 20 for receiving a stud weld fastener 22 and at least one arcuate bundle support surface 54 adapted for secure engagement with the elongate bundles 8 (shown in phantom). The mount member 14c further includes a base surface 28. As shown in FIG. 22, the mount member 14c is spatially located away from the support surface 11b. However, it should be noted that the base surface 28 may be adapted for supporting engagement with the support surface 11b of the metallic structural member 12. The mount member 14c may be further provided with an interior web 51. Interior web 51 provides added structural support to the mount member 14c.

As illustrated particularly in FIGS. 24 and 25, it can be seen that the bundle support surface 54 preferably includes an arcuate profile shape adapted to provide a snap fit for a bundle 8 secured within (see also FIG. 22). As such, the bundle support surface includes a compressible tab portion 56 that compresses to allow the bundle 8 to be snapped into the arcuate bundle support portion 54 and retains the bundle 8 after insertion. This arrangement creates a protective surrounding for the bundle 8 to minimize pinching and crushing of the bundle 8. The mount member 14c is further preferably provided with a ramped portion 58 for facilitating insertion of a bundle 8 into the bundle support area. As seen particularly in FIG. 25, the mount member 14c may include a stud aperture 20 having an irregular, generally undulating, inner surface 36. Further, the assembly includes a stud weld fastener 22 having an irregular portion 22d located intermediate the extension 22a and the base 22b. The irregular portion 22d is configured for mating engagement of the irregular, generally undulating inner surface 36 of stud aperture 20. FIG. 24a shows the embodiment of FIGS. 2225 with modified base 22b having pointed end 50.

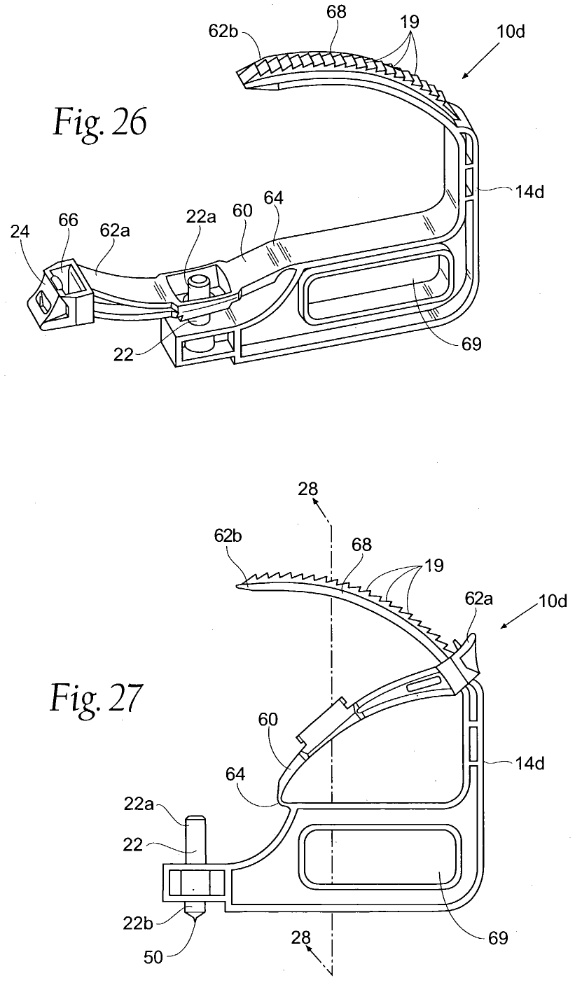

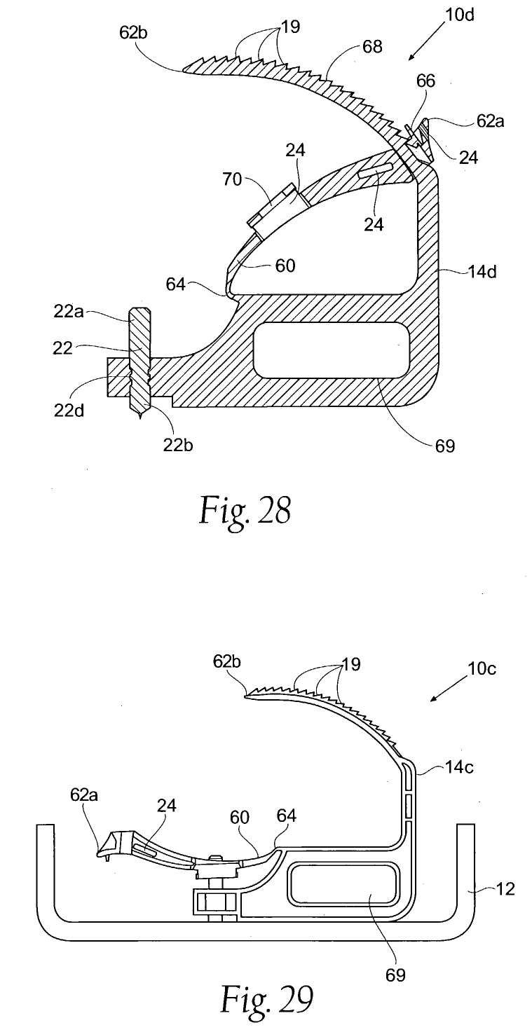

Referring now to FIGS. 26-29, inclusive, yet another embodiment mounting assembly 10d may be seen. As seen, the mount member 14d depicted in these views provides a cradle clamp device. The cradle clamp mount member 14d includes an open-ended loop 60 having first and second end portions 62a, 62b shaped and dimensioned to encircle a bundle 8 (not shown). The cradle clamp mount member 14d further includes a primary latch structure. In the illustrated embodiment, the primary latch structure takes the form of serrations 19 on one end 62b of the loop 60, and an interlocking tab or pawl 66 formed at the other end 62a. The flexible band 60 further includes a pivotable live hinge area 64 positioned between and integrally formed with the first and second end portions 62a, 62b. During the encircling of the cradle clamp mount member 14d around the elongate bundle 8, the hinge portion 64 allows the ends 62a, 62b to move toward each other for locking engagement of the serrations 17 and the pawl 66. As illustrated particularly in FIG. 28, the preferred primary latch structure 66 is seen as a pawl device 66 provided at end 62a of the open-ended loop 60. The pawl structure 66, as detailed in FIG. 28, is adapted to receive a serrated strap 68 extending from the end 62b of the loop 60. As observed in FIG. 28, the mount member 14d may include a stud aperture 20 having an irregular, generally undulating, inner surface 36. Similarly to the embodiment shown in FIGS. 13-15a, inclusive, the assembly seen in FIG. 28 includes a stud weld fastener 22 having an irregular portion 22d located intermediate the extension 22a and the base 22b. The irregular portion 22d is configured to mating engagement of the generally undulating, irregular inner surface 36 of stud aperture 20. FIG. 28 also shows a modified base 22b having an optional pointed end 50.

As seen particularly in FIG. 27, after the loop 60 is placed around a bundle 8 to be secured (not shown), the serrated strap 68 is passed through the pawl structure 66 to tighten the loop 60 around the bundle 8. A plurality of serrations or teeth 19 on the strap 68 prevents withdrawing movement of the strap 68.

The cradle clamp mount member 14d may further include at least one cable tie aperture 24 for receiving cable ties (not shown in these views), for securing additional elongate items to the mount 14d, and a through hole passage 69. Swivel mount hole 70 may be included for receiving additional mounting devices (devices not shown).

Preferably, all these structures have integrally formed cooperating elements, and the clamp 10 is molded as a unitary structure in a single manufacturing step.

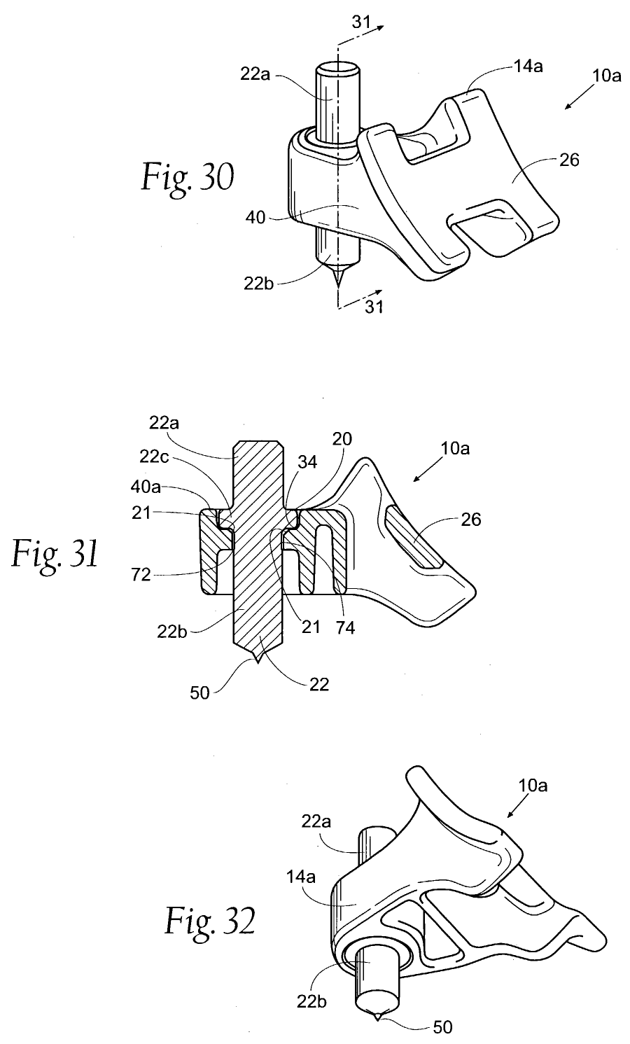

Referring now to FIGS. 30-32, another alternative embodiment mounting assembly 10a is shown. As viewed particularly in FIG. 31, the mount member 14a may include an arm 40 (FIG. 30) having an upper surface 40a including a countersunk portion 34. Countersunk portion 34 may be adapted to receive the radially extending ferrule 22c of stud fastener 22. As seen, the countersunk portion 34 further includes a beveled portion 21 and the stud aperture 20 includes a relatively constricted portion 72. The contour of the stud aperture 20 is adapted to receive a stud weld fastener 22 having a radially extending ferrule 22c and a relatively constructed portion 74. The relatively constricted portion 74 of the stud weld fastener is preferably located intermediate the ferrule 22c and the base portion 22b. As may be seen in these views, placement of the ferrule 22c in countersunk portion 34 allows the upper surface 40a of arm 40 to remain relatively smooth. Further, as illustrated in FIG. 32, the stud weld fastener 22 may include a base portion 22b having a sharply pointed end 50. As mentioned with reference to previous embodiments, a pointed end 50 may be desired, when for example, the metallic structural member 12 is painted and it is necessary to pierce the treated surface immediately prior to welding.

It has been noted in the embodiments that the extension 22a may be removed after welding. While this is possible and contemplated, it is not necessary for a bundle to be secured to the assembly, especially when the extension does not interfere with the bundle.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

What is claimed is:

1. A mounting assembly for securing an elongate object to a metallic support member, said support member including an exposed side, said assembly comprising:
a mount member interposed between said elongate object and said metallic support member, said mount member having a first surface and a second underside surface, said first surface being arranged for supporting engagement with said elongate object and said second surface being adapted for supporting engagement with said exposed side of said metallic support member, said mount member further including at least one tie aperture and a stud aperture;
an elongated tie including a strap portion, said strap portion being arranged to be received by said at least one tie aperture in said mount member and further being arranged to circumscribe said elongate object; and
a stud weld fastener, said fastener being arranged to be received in said at least one stud aperture and being further arranged to be stud welded to said metallic support member.

2. The assembly of claim 1 wherein said strap portion includes a distal end arranged to extend through said at least one tie aperture and to surround said elongate object.

3. The assembly of claim 1 wherein said mount member includes an angularly extending arm portion, said arm portion including said stud aperture and wherein the said arm portion includes an upper surface area, said upper surface area being relatively flat, said upper surface area arranged to receive said weld stud fastener.

4. The assembly of claim 3 wherein said stud weld fastener includes a supporting extension, a base portion and at least one radially extending ferrule, said radially extending ferrule being located intermediate the supporting extension and said base portion.

5. The assembly of claim 4 wherein said base portion includes a sharply pointed tip structure.

6. The assembly of claim 4 wherein said radially extending ferrule is engagable with said upper surface of said arm portion.

7. The assembly of claim 4 wherein said upper surface of said arm portion includes a countersunk portion, said countersunk portion being adapted to receive and seat said radially extending ferrule.

8. The assembly of claim 7 wherein said countersunk portion includes a beveled portion.

9. The assembly of claim 8 wherein said stud weld fastener further includes a constricted portion located intermediate said base portion and said at least one radially extending ferrule.

10. The assembly of claim 4 wherein said stud weld fastener includes a pair of spaced apart, radially extending ferrules.

11. The assembly of claim 10 wherein said upper surface and said underside surface of said arm portion each respectively including a countersunk portion, each of said countersunk portions adapted to receive a respective one of said pair of spaced apart, radially extending ferrules.

12. The assembly of claim 1 wherein said stud aperture includes an irregular, generally undulating, inner surface and wherein said stud weld fastener includes an irregular portion configured for mating engagement of said irregular inner surface.

13. The assembly of claim 4 wherein said stud aperture includes an annular-reentrant cavity adapted to receive said ferrule.

14. The assembly of claim 1 wherein said mount member includes an open ended loop having first and second end portions shaped and dimensioned to encircle said elongate object;
a primary latch structure integrally formed on the first and second end portions for securing the first and second ends to each other to secure the support legs to the elongate element; and
a pivotable live hinge positioned between and integrally formed with the first and second end portions.

15. A method of mounting an elongated object to an exposed surface of a metallic support member, said method comprising the steps of:
providing an elongated metallic stud weld fastener including a stud weld end portion and an extending end portion arranged for releasable engagement with a stud welding gun;
molding a mount member arranged to support said elongated object and being in secured molded relationship with said stud weld fastener;
configuring said mount member to include a surrounding surface area, said surrounding surface area supporting said stud weld fastener;
configuring said mount member to include a support surface for supporting engagement of said elongated object;
inserting the extending portion of said fastener in said stud welding gun;
stud welding said stud weld end portion of said fastener to said metallic support member; and
securing said elongate object to said mount member.

16. The method of claim 15 including the step of severing and removing said fastener extending end portion from said mount member.

17. The method of claim 15 including the steps of:
providing said mount member with at least one tie aperture and an elongated tie including a strap portion arranged to be received by said at least one aperture located in said mount member;
providing a strap locking member in said tie;
threading one end of said strap portion through said at least one aperture located in said mount member;
circumscribing said strap around said object; and
securing said strap to said tie locking means.

18. A method of mounting an elongated object to an exposed surface of a metallic support member, said method comprising the steps of:
providing an elongated metallic stud weld fastener including a stud weld end portion and an extending end portion, said extending end portion arranged for releasable engagement with a stud welding gun;
providing an elongate strap member;
molding a mount member, having a strap aperture, and being arranged to support said elongated object and further being arranged to receive said stud weld fastener in a stud aperture;
providing a stud welding gun;
inserting said stud weld fastener in said stud aperture;
inserting said extending end in a stud welding gun;
stud welding said stud weld fastener to said exposed surface of said metallic support member;
inserting said strap member in said strap aperture; and
circumscribing said elongated object with said strap member.

19. A mounting assembly for securing an elongate object to a metallic support member, said support member including an exposed side, said assembly comprising:
a mount member interposed between said elongate object and said metallic support member, said mount member having a first surface and a second surface, said first surface being arranged for supporting engagement with said elongate object and said second surface being adapted for supporting engagement with said exposed side of said metallic support member, said mount member further including at least one stud aperture; and
a stud weld fastener, said fastener being arranged to be received in said at least one stud aperture and being further arranged to be welded to said metallic support member.

20. The mounting assembly of claim 19 further including at least one snap fit mounting recess located on said mount member.

21. The mounting assembly of claim 20 wherein said at least one snap fit mounting recess includes a compressible tab portion.

22. A method of mounting an elongated object to an exposed surface of a metallic support member, said method comprising the steps of:
providing an elongated metallic stud weld fastener including a stud weld end portion and an extending end portion arranged for releasable engagement with a stud welding gun;
molding a mount member arranged to support said elongated object and being in secured molded relationship with said fastener;
inserting the extending portion of said fastener in said stud welding gun;
stud welding said stud weld portion of said fastener to said metallic support member; and
securing said elongate object to said mount member.

23. The method of claim 22 including the step of severing and removing said fastener extending end portion from said mount member.
